(19) United States
(12) Patent Application Publication
(10) Pub. No.: US 2003/0076744 A1
(43) Pub. Date: Apr. 24, 2003

(54) Field monitoring instrument

(76) Inventor: Kenneth E. Zick, Fort Wayne, IN (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/982,460

(22) Filed: Oct. 18, 2001

(51) Int. Cl. G04F 8/00; G04F 10/00

(52) U.S. Cl. 368/9; 368/107

(57) ABSTRACT

A monitoring apparatus for use with an electrical appliance to record and display the electrical appliance's actual accumulated operating time and record and display the number of times the electrical appliance has been energized since the time the monitoring apparatus was installed or last reset. The monitoring apparatus may include a current detector, a time recorder, and a counter for detecting and recording operation time and number of start-ups.

### FIELD OF THE INVENTION

The present invention relates to equipment monitoring, and, more particularly, to monitoring electrical equipment running time and number of start ups.

### BACKGROUND OF THE INVENTION

There are many electrical appliances and equipment that, over time, decline in productivity or fail altogether. Often the events leading to a failure are unknown and unascertainable by the time of the failure.

It is believed that for many electrical appliances that the time the appliances are in actual operation contributes significantly to failures. Naturally, products including electrical appliances wear out and decline in usefulness over time. However, often it is unknown whether a particular problem or failure was due to everyday wear and tear over many hours of use, or by some other event or events. It may be difficult or impossible to guess with any accuracy how many hours the appliance had been in actual operation prior to encountering problems. It is critical for an appliance designer and manufacturer to know whether the failure is due to normal wear or some other unforeseen defect. Therefore, in order for a designer or manufacturer to increase the reliability of the electrical appliances he produces, the hours of operation prior to failure need to be known.

In addition, it is believed that the number of times an appliance is started and stopped also contributes to the longevity of the appliance. Wear and stress are believed to be significantly increased during the start up of most appliances as compared to normal operation. However, again, it is quite uncommon for a user to know with any degree of certainty how many times an appliance has beep started and stopped.

Accordingly, designers and manufacturers need a baseline of field data relating to the normal operating life of the appliances they design and produce. The designers, for example, may find data on operational hours and start-ups very useful as they plan product changes. For example, if a designer had access to field data concerning the products he designed, he may be able to find that he had over-designed a particular pump and that the pump could be designed to last a normal service lifetime with less expensive components. The designer may also find the contrary to be true—that the pumps often fail prior to fulfilling a normal service life. However, useful field data on electrical appliance operation and start-ups is not readily available.

Appliance operational data could also be vital in determining warranty provisions offered to customers for a particular product. If the seller of an electrical appliance had data concerning the number of hours the appliance could be expected to normally operate effectively, a time-specific warranty could be well crafted to the data. Unfortunately, such data is difficult or impossible to compile by presently known methods.

Further, in cases in which failures of electrical appliances are under analysis, if data concerning the number of starts was readily available, it may shed light on what the failure resulted from. If the appliance was started an inordinate number of times, perhaps the user was misusing the appliance or another esoteric problem relating to unplanned stops and starts could be investigated. However, data relating to starts and stops of electrical appliances is not readily available.

The present invention attempts to eliminate, or at least reduce the effects of, one or more of the problems stated above.

### SUMMARY OF THE INVENTION

The present invention meets the above-described needs and others. Specifically, the present invention provides a monitoring apparatus including a current detector; a time recorder coupled to the current detector; and a counter coupled to the current detector. The current detector may be an alternating current (AC) detector. The time recorder may be an hourmeter including a viewable display. The display may be a digital liquid crystal display (LCD). The hourmeter may include a lithium battery. The counter may also include a viewable display. The viewable display of the counter may be a liquid crystal display. The counter may also include a lithium battery.

In some embodiments of the present invention the monitoring apparatus further includes a chassis to house the current detector. The time recorder and counter may be mounted to a surface of the chassis. The chassis may further include a power cord for plugging into a power receptacle, and a monitor power receptacle for receiving a power cord of an electrical appliance to be monitored. The power cord and monitor power receptacle may be household two, three, or four prong cords and receptacles.

In some embodiments of the present invention the electrical appliance to be monitored is a pump.

In some embodiments the current detector includes a sensor hole with a power lead extending therethrough at least once, and the power lead may be electrically connected to the electrical appliance. In some embodiments the power lead is looped through the sensor hole at least twice.

In some embodiments of the present invention a voltage output is produced by the current detector in response to a current in the power lead. The voltage output may be proportional to the current in the power lead. In some embodiments the voltage output ranges between zero and five volts, while in others the voltage output ranges between three and five volts.

In some embodiments of the present invention the time recorder is induced to a running state in response to the voltage output of the current detector. The time recorder may be induced to the running mode at any voltage output equal to or greater than three volts. The time recorded by the time recorder in the running state may be cumulative from the time the monitoring apparatus is installed or reset.

In some embodiments of the present invention the counter increments by one count in response to a voltage output change from approximately zero volts to a positive or negative voltage.

In some embodiments the monitoring apparatus uses no external power sources to operate the time recorder and counter.

In one embodiment of the present invention there is provided a monitoring apparatus including an electrical appliance; a power source for the electrical appliance; and a monitor electrically connected between the power supply and the electrical appliance for recording hours of operation and number of starts of the electrical appliance. The electrical appliance may be a sump pump. The power supply may be a 120 VAC power outlet. The monitor may include a current detector; an hourmeter coupled to the current detector; and a counter coupled to the current detector. The monitor may also include a chassis, and the current detector may be disposed within the chassis, with the hourmeter and counter mounted to an outer surface of the chassis. The current detector may be a Syscon International CV-1-5 AC current detector, the hourmeter may be a Reddington 5320-1000 hourmeter, and the counter may be a Reddington 5300-1000 digital counter.

In one embodiment of the present invention there is disclosed a method of monitoring electrical appliance run time including the steps of running the electrical appliance power current through a monitor and recording and the time the appliance is energized on the monitor. The power current may run through the monitor before it reaches the electrical appliance. The method may also include recording the number of starts of the electrical appliance. The method may also include the step of displaying accumulated time the appliance has been energized. The monitor may include a current detector; an hourmeter coupled to the current detector; a counter coupled to the current detector; a power cord adapted for use with a household power outlet; and a power receptacle receptive of a two, three, or four-pronged household power cord of the electrical appliance.

In one embodiment of the present invention there is disclosed a method of counting the starts of an electrical appliance including the steps of: running a current of the electrical appliance through a monitor, and incrementing a counter of the monitor by one count each time the monitor detects a change in the current from approximately zero amps to a positive amp value. The method may further include recording the time the current is at a positive value. According to the method a start count number and an appliance run time number may be recorded on the monitor and shown on a visual display.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The features and inventive aspects of the present invention will become more apparent upon reading the following detailed description, claims, and drawings, of which the following is a brief description:

FIG. 1 is a front view of a monitor connected to an electrical apparatus according to one embodiment of the present invention.

FIG. 2 is a schematic of the monitor shown in FIG. 1.

Throughout the drawings, identical elements are designated by identical reference numbers.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, that will vary from one implementation to another. Moreover, it will be appreciated that such a development effort might be complex and time-consuming, but would nevertheless be a routine undertaking for those of ordinary skill in the art having the benefit of this disclosure.

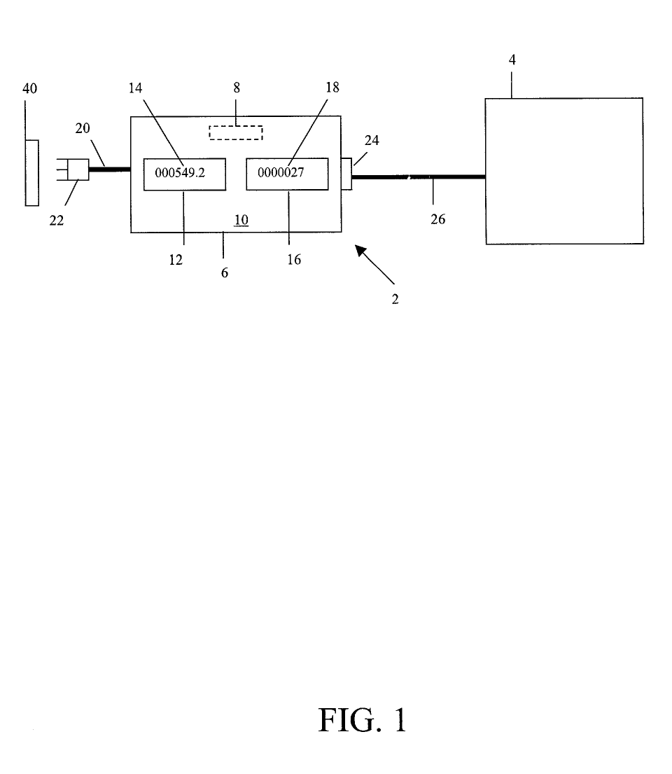

Turning now to the figures, and in particular to FIG. 1, a monitoring apparatus (2) in accordance with one aspect of the present invention is shown. Monitoring apparatus (2) is an electrical appliance monitor. For example, monitoring apparatus (2) may be coupled with a sump pump (4). However, it will be understood by those of skill in the art with the benefit of this disclosure that monitoring apparatus (2) may be used to monitor any electrical appliance including, but not limited to, pumps, motors, compressors, lights, tools, and equipment.

Monitoring apparatus (2) may be used to monitor the time an electrical appliance is in operation and/or drawing current. Monitoring apparatus (2) may also be used to count the number of start-ups the electrical appliance undergoes. The monitoring of time and start-ups may be done by separate apparatus, or, as in the present embodiment, monitoring apparatus (2) may function to monitor both time of operation and count the number of start-ups.

Monitoring apparatus (2) may include a housing, for example chassis (6), to house one or more components, for example a current sensor (8). The details and operation of current sensor (8) are discussed below.

Chassis (6) may also include a surface (10) to which other components may be mounted. In the embodiment shown, a time recorder, for example hourmeter (12), is mounted to surface (10) of chassis (6). Hourmeter (12) may be available from Reddington, for example a Reddington 5320-1000 hourmeter may be used. Hourmeter (12) may have a viewable display, for example a liquid crystal display (LCD) (14). LCD (14) may be viewable to a user to determine how many hours sump pump (4), or any other electrical appliance to which monitoring apparatus (2) is connected, has been in operation and/or drawing an electrical current. The LCD (14) of Hourmeter (12) may include seven digits, including increments of one-tenth of an hour, however, this is not necessarily so. Any number of digits and time increments may be used.

Hourmeter (12) may include a battery, for example a lithium battery, to provide power to the LCD (14) independent of any other power source. Further, the viewable display need not be an LCD display, an analog display, LED display, or other display may also be used.

Hourmeter (12) may be programmed to accumulate the time sump pump (4) is in operation or drawing current, or, if desired, the hourmeter may be programmed to re-start sump pump (4) running time each time the pump is re-started. Hourmeter (12) advantageously allows a user to determine with accuracy how long sump pump (4) or any other electrical appliance has been in operation or drawing current.

Also mounted to surface (10) of chassis (6) is a counter (16). Counter (16) is also available from Reddington, for example a Reddington 5300-1000 counter may be used. Like hourmeter (12), counter (16) may have a viewable display, for example LCD (18). LCD (18) may be viewable to a user to determine how many times sump pump (4), or any other electrical appliance to which monitoring apparatus (2) is connected, has been started. LCD (18) may be a seven digit display, including whole number increments, but this is not necessarily so. Counter (16) may include a battery, for example a lithium battery, to provide power to the LCD (18) independent of any other power source. Further, counter (16) may include any other convenient display in place of, or in addition to, LCD (18); including, but not limited to, an analog display, and LED display, or other display.

Chassis (6) of monitoring apparatus (2) may include a power cord, for example household power cord (20). Household power cord (20) may include a plug, for example standard three prong plug (22). However, standard three prong plug (22) may also be replaced by other plugs including, but not limited to, a standard two prong plug, a four prong plug, a 240 volt three or four-prong plug, or other plug. Standard three prong plug (22) may be adapted for insertion into a household 120 VAC (Alternating Current Volts) receptacle (40), however, other prongs may be used for power receptacles of different power supplies, such as a 240 VAC power supply.

Chassis (6) may also include a power receptacle, for example household power receptacle (24) for receiving a power cord (26) of pump (4) or any other electrical appliance. In the embodiment shown, household power receptacle (24) and household power cord (20) are arranged on opposite side of chassis (6), but this is not necessarily so. Monitoring apparatus (2) is, in the embodiment shown, arranged between the power supply and the electrical appliance intended to be monitored. As current (alternating or direct) is provided from a power supply to an electrical appliance such as sump pump (4), monitoring apparatus (2) records the hours of operation on hourmeter (12) and displays the hours on LCD (14). Further, the number of start-ups is recorded by counter (16) and displayed on LCD (18).

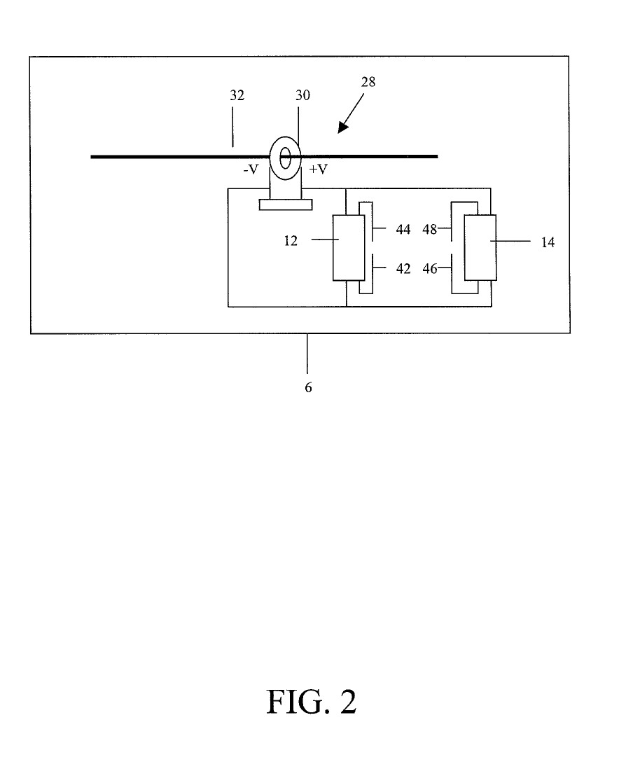

Turning next to FIG. 2, a schematic of monitoring apparatus (2) is shown. Monitoring apparatus (2) may include a current sensor (28) housed in chassis (6). Current sensor (28) may be available from Syscon International, for example a Syscon International CV-1-5 model current sensor may be used. Current sensor (28) includes a sensor hole (30) though which a power lead (32) of household power cord (20) may pass at least once. As current is drawn by sump pump (4), current sensor (28) outputs a DC voltage proportional to the current sensed. The Syscon CV-1-5 current sensor outputs a voltage between zero and five volts, depending on the current carried by the power lead looped though sensor hole (30). In some embodiments power lead (32) may be looped two or more times through sensor hole (30) to increase the sensitivity of current sensor (28). Multiple loops may be necessary for electrical appliances that may draw small currents even during normal operational mode.

Hourmeter (12), if it is the Reddington model referenced above, operates when the voltage thereacross reaches three volts or more. That is, if at least three volts measure across hourmeter (12), the hourmeter is induced into “running” mode and therefore records and displays the accumulated time that the voltage is at least three volts thereacross. A voltage of three volts or more may indicate that sump pump (4) or another appliance is in operation and drawing current. The voltage across hourmeter (12) indicates appliance operation because the Syscon CV-1-5 current sensor outputs a DC voltage of at least three volts when AC current being drawn is at least three amps. Therefore, if an electrical appliance such as sump pump (4) may have the possibility of drawing fewer than three amps during operation, power lead (32) may be looped two or more times through sensor hole (30) to induce a “sensed” current of at least three volts. It will be understood by those of skill in the art with the benefit of this disclosure, however, that time recorders and counters may be available that are sensitive to voltages of less than three volts and that the embodiment described is exemplary in nature. For example, if sump pump (4) is capable of operating at one and one-half amps, power lead (32) may be looped through sensor hole (30) twice, and therefore a current draw of one and one-half amps by sump pump (4) will still result in an output voltage of three volts—enough to induce hourmeter (12) to the running or recording and displaying mode.

Similarly, counter (16), if it is the Reddington model referenced above, also operates when the voltage thereacross reaches three volts or more (from an initial voltage value between zero and less than 3 volts, which is defined herein as approximately zero volts). That is, each time the voltage across counter (16) increases from approximately zero volts to a measurement of three volts or greater, the counter increments by one count and displays the accumulated count number. A voltage starting at approximately zero volts and reaching three volts or more may indicate that sump pump (4) or another appliance has been started. In the embodiment shown, counter (16) is in electrical parallel with hourmeter (12), such that each “sees” the same voltage output from current sensor (28). Again, the voltage across counter (16) increasing beyond three volts indicates an appliance start-up and possibly operation, because the Syscon CV-1-5 current sensor outputs a DC voltage of at least three volts when AC current being drawn is at least three amps. Therefore, if an electrical appliance such as sump pump (4) may have the possibility of drawing fewer than three amps during start up, power lead (32) may be looped two or more times through sensor hole (30) to induce a “sensed” current of at least three volts.

Both hourmeter (12) and counter (16) may be reset to the zero setting (diplays showing all zeroes) by applying a three to thirty volt DC voltage across a separate pair of reset terminals (42-48) present on each device. A user may employ a battery plug with a common nine-volt battery for resetting purposes. Leads (42 and 44) of hourmeter (12) and leads (46 and 48) of counter 14 may be brought out to the chassis surface (10) such that the terminals of a nine-volt battery (not shown) could be momentarily touched to terminal pairs (42 and 44 or 46 and 48) to reset (zero) the LCD displays of hourmeter (12) and counter (16) separately.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A monitoring apparatus comprising:
a current detector;
a time recorder coupled to the current detector; and
a counter coupled to the current detector.

2. The apparatus of claim 1, wherein the current detector is an alternating current (AC) detector.

3. The apparatus of claim 1, wherein the time recorder comprises an hourmeter including a viewable display.

4. The apparatus of claim 3, wherein the display comprises a digital liquid crystal display.

5. The apparatus of claim 3, wherein the hourmeter comprises a battery.

6. The apparatus of claim 4, wherein the battery is a lithium battery.

7. The apparatus of claim 1, wherein the counter comprises a viewable display.

8. The apparatus of claim 7, wherein the viewable display comprises a liquid crystal display.

9. The apparatus of claim 8, wherein the counter comprises a battery.

10. The apparatus of claim 9, wherein the battery is a lithium battery.

11. The apparatus of claim 1, further comprising a chassis to house the current detector.

12. The apparatus of claim 11, wherein the time recorder and counter are mounted to a surface of the chassis.

13. The apparatus of claim 11, wherein the chassis further comprises a power cord for plugging into a power receptacle, and a monitor power receptacle for receiving a power cord of an electrical appliance to be monitored.

14. The apparatus of claim 13, wherein the power cord and monitor power receptacle are household two, three, or four prong cords and receptacles.

15. The apparatus of claim 13, wherein the electrical appliance to be monitored is a pump.

16. The apparatus of claim 1, wherein the current detector comprises a sensor hole with a power lead extending therethrough at least once.

17. The apparatus of claim 16, wherein the power lead is looped through the sensor hole at least twice.

18. The apparatus of claim 17, wherein the power lead is electrically connected to an electrical appliance to be monitored.

19. The apparatus of claim 16, wherein a voltage output is produced by the current detector in response to a current in the power lead.

20. The apparatus of claim 19, wherein the voltage output is proportional to the current in the power lead.

21. The apparatus of claim 20, wherein the voltage output ranges between zero and five volts.

22. The apparatus of claim 21, wherein the voltage output ranges between three and five volts.

23. The apparatus of claim 19, wherein the time recorder is induced to a running state in response to the voltage output from the current detector.

24. The apparatus of claim 23, wherein the time recorder is induced to the running mode at any voltage output equal to or greater than three volts.

25. The apparatus of claim 23, wherein time recorded by the time recorder in the running state is cumulative.

26. The apparatus of claim 19, wherein the counter increments by one count in response to a voltage output change from approximately zero volts to a positive or negative voltage.

27. The apparatus of claim 1, wherein the apparatus uses no external power sources to operate the time recorder and counter.

29. A monitoring apparatus comprising:
an electrical appliance;
a power supply for the electrical appliance; and
a monitor electrically connected between the power supply and the electrical appliance for recording hours of operation and number of starts of the electrical appliance.

30. The monitoring apparatus of claim 29, wherein the electrical appliance comprises a sump pump.

31. The monitoring apparatus of claim 29, wherein the power supply is a 120 VAC power outlet.

32. The monitoring apparatus of claim 29, wherein the monitor comprises:
a current detector;
an hourmeter coupled to the current detector; and
a counter coupled to the current detector.

33. The monitoring apparatus of claim 32, wherein the monitor further comprises a chassis, and the current detector is disposed within the chassis, with the hourmeter and counter mounted to an outer surface of the chassis.

34. The monitoring apparatus of claim 32, wherein the current detector comprises a Syscon International CV-1-5 AC current detector, the hourmeter comprises a Reddington 5320-1000 hourmeter, and the counter comprises a Reddington 5300-1000 digital counter.

35. A method of monitoring electrical appliance run time comprising the steps of:
running the electrical appliance power current through a monitor; and
recording and the time the appliance is energized on the monitor.

36. The method of claim 35, wherein the power current runs through the monitor before it reaches the electrical appliance.

37. The method of claim 36, further comprising recording the number of starts of the electrical appliance.

38. The method of claim 35, further comprising the step of displaying accumulated time the appliance has been energized.

39. The method of claim 35, wherein the monitor comprises:
a current detector;
an hourmeter coupled to the current detector;
a counter coupled to the current detector;
a power cord adapted for use with a household power outlet; and
a power receptacle receptive of a two, three, or four-pronged household power cord of the electrical appliance.

40. A method of counting the starts of an electrical appliance comprising the steps of:
running a current of the electrical appliance through a monitor, and
incrementing a counter of the monitor by one count each time the monitor detects a change in the current from approximately zero amps to a positive amp value.

41. The method of claim 40, further comprising recording the time the current is at a positive value.

42. The method of 41, wherein a start count number and an appliance run time number are recorded on the monitor and shown on a visual display.
